(19) United States
(12) Patent Application Publication
(10) Pub. No.: US 2006/0271305 A1
(43) Pub. Date: Nov. 30, 2006

(54) Optimal dynamic discrimination of similar molecular scale systems using functional data

(75) Inventor: Herschel Rabitz, Lawrenceville, NJ (US)

Correspondence Address: COOPER & DUNHAM, LLP, 1185 AVENUE OF THE AMERICAS, NEW YORK, NY, 10036, US

(73) Assignee: The Trustees of Princeton University

(21) Appl. No.: 11/361,508

(22) Filed: Feb. 24, 2006

Related U.S. Application Data
(60) Provisional application No. 60/656,502, filed on Feb. 25, 2005.
(60) Provisional application No. 60/675,602, filed on Apr. 28, 2005.

(51) Int. Cl. G06F 19/00

(52) U.S. Cl. 702/19; 702/22

(57) ABSTRACT

Techniques for molecular scale discrimination using functional data are provided. A method for molecular scale discrimination using functional data can include, for example, (a) applying a control pulse to excite one or more molecular species in a molecular scale system, (b) collecting functional data for an observable variable from the molecular scale system after the control pulse is applied in (a), (c) adjusting the control pulse under the control of a closed loop controller, for dynamically discriminating one of a plurality of molecular species in the molecular scale system from another molecular species in the molecular scale system, and repeating (a) and (b) with the adjusted control pulse, and (d) discriminating the one molecular species from the other molecular species in the molecular scale system, by using the collected functional data.

### CROSS-REFERENCE TO RELATED APPLICATIONS

This application claims the benefit of the following U.S. Provisional Applications, the entire contents of each of which are incorporated herein by reference:

Ser. No. 60/656,502, filed Feb. 25, 2005 and entitled “OPTIMAL DYNAMIC DISCRIMINATION OF SIMILAR MOLECULAR SCALE SYSTEMS USING FUNCTIONAL DATA”; and

Ser. No. 60/675,602 filed Apr. 28, 2005 and entitled “OPTIMAL DYNAMIC DISCRIMINATION OF SIMILAR MOLECULAR SCALE SYSTEMS USING FUNCTIONAL DATA”.

This invention was made with government support under NSF grant CHE-0415509, and ARO-MURI grant DAAD19-01-1-0560. Accordingly, the U.S. Government has certain rights in the invention.

### FIELD

The present disclosure relates to chemical and biological agent discrimination for laboratory, clinical, environmental, and field use, and, more specifically, to optimal dynamic discrimination of similar molecular scale systems using functional data.

### BACKGROUND

There is presently an ongoing need to develop molecular detection technologies that can readily identify chemical and biological agents present in the environment. Unfortunately, the detection of such agents (for example, molecules) is often complicated by complex background interference arising from the presence of a variety of other components in test samples. This problem is especially evident where an agent targeted for detection (for example, a dangerous chemical warfare agent or a virulent biological agent) is intentionally mixed with similarly structured agents to mask its presence. Typically, mixtures of such components require time-consuming separation processes for reducing the uncertainty in identifying a particular agent among a myriad of other components. There is a need for detection techniques which efficiently discriminate chemical and biological agents from a mixture of components without the need for a separate separation step.

A list of publications may be found in the References section immediately preceding the claims. The disclosures of these publications are hereby incorporated by reference in their entireties into this application in order to more fully describe the state of the art to which this application pertains.

### SUMMARY

This disclosure describes assorted techniques which can be adapted for chemical and biological agent discrimination and identification.

For example, methods for molecular scale discrimination using functional data are described. A method for molecular scale discrimination using functional data, according to one exemplary embodiment, can include the steps of: (a) applying a control pulse to excite one or more molecular species in a molecular scale system; (b) collecting functional data for an observable variable from the molecular scale system after the control pulse is applied in step (a); (c) adjusting the control pulse under the control of a closed loop controller, for dynamically discriminating one of a plurality of molecular species in the molecular scale system from another molecular species in the molecular scale system, and repeating steps (a) and (b) with the adjusted control pulse; and (d) discriminating the one of the plurality of molecular species in the molecular scale system from the other molecular species in the molecular scale system, by using the collected functional data.

Dynamic discriminators for a molecular scale system are also described in this application. According to an exemplary embodiment, the dynamic discriminator for a molecular scale system includes a control pulse generator, a detector, a closed loop controller and a species discrimination part. The control pulse generator generates a control pulse. The detector collects functional data for an observable variable from a molecular scale system after the control pulse generated by the control pulse generator is applied to the molecular scale system to excite one or more molecular species in the molecular scale system. The closed loop controller uses a close loop technique to control generation of the control pulse by the control pulse generator, for dynamically discriminating one of a plurality of molecular species in the molecular scale system from other molecular species in the molecular scale system. The species discrimination part discriminates the one of the plurality of molecular species in the molecular scale system from the other molecular species in the molecular scale system, by using the collected functional data.

### BRIEF DESCRIPTION OF THE DRAWINGS

FIG. 1a: A graph of generic observation Oᵢ(x) as a function of generic observable variable x.

FIG. 1b: A graphical representation of optimal dynamic discrimination, according to an exemplary embodiment.

FIG. 2: A block diagram for a dynamic discriminator apparatus, according to an exemplary embodiment of this application.

FIG. 3: A flow chart for a method for molecular scale discrimination using functional data, according to an exemplary embodiment.

FIGS. 4-1a through 4-1c: The distribution of one hundred c¹ measurements from a random pulse (generation 0—FIG. 4-1a) and the best control pulse (genome) at generations 30 (FIG. 4-1b) and 500 (FIG. 4-1c) for the case of perfect temporal resolution (δt=0). The actual concentration is c¹=0.2. Application of the final optimal control in FIG. 4-1c dramatically enhances the quality of the extracted concentration distribution.

FIGS. 4-2a through 4-2c: The distribution of one hundred c¹ measurements from a random pulse (generation 0—FIG. 4-2a) and the best control pulse (genome) at generations 30 (FIG. 4-2b) and 500 (FIG. 4-2c) for the case of finite temporal resolution (δt =0.5). The actual concentration is c¹=0.2. Application of the final optimal control in FIG. 4-2c dramatically enhances the quality of the extracted concentration distribution. Despite the fact that the distribution at generation 0 is broader in this case than in FIG. 4-1a, at convergence in generation 500 the optimal field has overcome the low temporal resolution.

FIGS. 4-3a and 4-3b: The time profiles of O^{v}(t) at perfect time resolution (δt =0) with no noise in the control pulse or the signal, guided by a random control pulse (FIG. 4-3a), and guided by the best control pulse from the GA optimization (FIG. 4-3b).

FIGS. 4-4a and 4-4b: The time profiles of O^{v}(t) at finite time resolution (δt =0.5) with no noise in the control pulse or the signal, guided by a random control pulse (FIG. 4-4a), and guided by the best control pulse from the GA optimization (FIG. 4-4b). Note the loss of resolved structure upon comparison with FIGS. 4-3a and 4-3b and also the enhanced distinction between the signals achieved by the optimal control field in FIG. 4-4b versus that in FIG. 4-3b. In the case of finite time resolution in the case of FIG. 4-4b, the optimal control compensates for the loss of features in the signals by enhancing the differences between the signals.

FIG. 4-5: The standard deviation of one hundred c¹ measurements at different levels of time resolution δt. The actual concentration is c¹=0.02. In (a) and (b) the cost functional is the average standard deviation of all three species, (a) the control pulse at each δt yields the best average standard deviation of all three species, (b) the control pulse at each δt is singled out that produces the best standard deviation of species 1. (c) the cost functional is the standard deviation of species 1, and the control pulse at each δt yields the best standard deviation of species 1.

FIGS. 4-6a through 4-6c: The distribution of one hundred c¹ measurements from a random pulse (generation 0—FIG. 4-6a) and the best control pulse (genome) of generations 30 (FIG. 4-6b) and 500 (FIG. 4-6c) for the case of perfect temporal resolution (δt=0). The actual concentration is c¹=0.02. The cost function J=(σ¹/\overline{c}¹+σ²+σ³)/3 guiding the closed loop operations provides focused attention on species 1 in balance with stable extraction of species 2 and 3 as well. Application of the final optimal control in FIG. (6c) dramatically enhances the quality of the extracted concentration distribution for species 1. Note that the peak near zero concentration at generation 0 arises from the constrained least-square method preventing the concentrations from being negative.

FIG. 4-7a: Table of standard deviations of extracted concentrations. The true concentrations are c¹=0.2, c²=0.5, c³=0.9, and there is perfect time resolution δt=0. The standard deviation is from the one hundred measurements of the best control pulse (genome) at each specific GA (genetic algorithm) generation.

FIG. 4-7b: Table of standard deviations of extracted concentrations. The true concentrations are c¹=0.2, c²=0.5, c³=0.9, and there is finite time resolution δt=0.5. The standard deviation is from the one hundred measurements of the best control pulse (genome) at each specific GA generation.

FIG. 5-1: The relationship between the concentration average standard deviation a for the three similar species and the decoherence strength Q. The standard deviations are calculated from one hundred measurements using the best control pulse at the 100th generation of GA optimization.

FIGS. 5-2a1 through 5-2b2: The distribution of one hundred c¹ measurements from a random pulse at the 0th generation and the best pulse at the 100th generation for (a) Q=10⁻⁵ (FIGS. 5-2a1 and 5-2a2) and (b) Q=0.01 (FIGS. 5-2b1 and 5-2b2). The mean concentration of each distribution is shown by the line labeled by \overline{c}¹. The true value of c¹ is 0.2, and the plots show that after 100 generations the optimal field improved \overline{c}¹ and significantly enhanced the quality of the extracted concentrations.

FIGS. 5-3a and 5-3b: The time profiles of O^{v}(t) guided by (a) a random control pulse (FIGS. 5-3a) and (b) the best control pulse at generation 100 for Q=10⁻⁵ (FIG. 5-3a). Note that the signal scales are different in FIGS. 5-3a and 5-3b, with the optimal pulse producing a significantly enhanced signal for better discrimination.

FIG. 5-4: The relationship between the concentration average standard deviation \overline{σ} for the three similar species and the number of signals P. The decoherence strength is Q=0.01, and similar behavior shows up at other Q values. The standard deviations are calculated from one hundred measurements using the best control pulse at the 100th generation of GA optimization.

FIG. 5-5: The relationship between the concentration average standard deviation a for the three similar species and the temperature T (expressed in units of E₁¹/k_{B} where E₁¹ is the lowest state of species 1 and k_{B} is Boltzmann's constant). The decoherence strength is Q=0.01, and similar behavior shows up at other Q values. The standard deviations are calculated from one hundred measurements using the best control pulse at the ₁₀₀th generation of GA optimization.

FIG. 5-6: The initial population distribution given by the diagonal elements of the density matrix of species 1 at time −τ.

FIG. 5-7: The mean and the standard deviations of the extracted concentrations. The mean \overline{c}^{v} and the standard deviations σ^{v} of the extracted concentrations are determined in Eq. (5-19) from one hundred measurements of the best control pulse at the specified GA generations. The true concentrations are c¹=0.2, c²=0.5, c³=0.9.

### DETAILED DESCRIPTION

The following discussions of theory and exemplary embodiments are set forth to aid in an understanding of the subject matter of this disclosure but are not intended to, and should not be construed to, limit in any way the invention as set forth in the claims which follow thereafter.

In order to facilitate an understanding of the discussion which follows one may refer to S. Rice and M. Zhao, Optical Control of Molecular Dynamics, (John Wiley and Sons, New York 2000) for certain frequently occurring methodologies and/or terms which are described herein.

Similar quantum systems have comparable Hamiltonians, and thus similar conventional chemical, physical, and spectral properties. There is much interest in detecting one molecular species, including its concentration, in a molecular scale system in the presence of other similar species in the molecular scale system. Although such species may be spectrally similar, each of the species can have significantly different quantum dynamical behavior for detection.

The term “molecular species” as used herein can refer to a single type of molecule, or a conglomerate of molecules forming a complex body including, for example, living organisms such as a cell.

Optimal dynamic discrimination (ODD) techniques have been previously discussed for maximally discriminating between similar molecular species. For example, use of quantum control to discriminate amongst chemical and biological agents is discussed in commonly owned U.S. applications Ser. No. 10/322,693, filed Dec. 18, 2002, and Ser. No. 10/505,941, filed Aug. 25, 2004, the disclosures of which are incorporated herein in their entireties by reference. The techniques discussed in Ser. No. 10/322,693 and Ser. No. 10/505,941 can be extended as discussed herein, to lay out a general procedure for molecular scale discrimination based on using closed loop control techniques with functional data.

The term “functional data”, as used herein, can be explained exemplarily with reference to FIG. 1. FIG. 1 shows a generic observation Oᵢ(x) as a function of an observable independent variable x. The observation may be, for example, intensity associated with a variety of signals, such as any type of spectral absorption, light or particle scattering, mass spectral intensity data, etc. The independent variable x may be frequency, time, or mass. The variable x may therefore be continuous or discreet. In addition, x may correspond to any of assorted combinations of such variables (for example, multi-time scale NMR, multi-frequency spectroscopy, etc.). Assuming that the signal from each species is linearly proportional to its concentration, the overall laboratory signal can be expressed as follows:

$$O ( x ) = {\sum }_{i = 1}^{N} {c}_{i} {O}_{i} ( x )$$

where cᵢ (i=1,2, . . . , N) is the concentration of the i-th molecular species present and N is the total number of such species.

One practical purpose of the techniques of this disclosure is to take optimal laboratory data for determining the concentrations cᵢ, i=1,2, . . . , N. An external control can be introduced for this purpose and a control pulse such as an electromagnetic radiation pulse, an electrical pulse, or a chemical pulse (for example, flux), may be applied to the molecular scale system. In a preferred embodiment, these controls are suitably shaped in time, frequency, and/or space, and closed loop control is applied in order to achieve a maximum degree of signal discrimination between the species present (as discussed below exemplarily for an example of time series data).

A cost function, such as the following cost function J, can be used to guide the optimal choice of these controls, where ω₁ is a weight function depending on the statistical variance σ₁ of the 1-th species concentration c₁:

$$J = {\sum }_{ℓ = 1}^{N} {ω}_{ℓ} ( {σ}_{ℓ} )$$

Other more complex forms of the cost J may be used and considered, allowing for emphasis on particular agents that deserve the most attention for concentration extraction. The cost J may be used by a closed loop machine to optimally determine the best control that can most reliably extract the molecular components present considering all of the observation data as a function of the independent variable x. Simplified cases may arise where only a sub-component of the data at selected values of x is utilized, with the extreme situation of the data being taken at only a single value of x.

The overall process can work optimally with a real laboratory or field situation containing noise and other disturbing clutter to maximally draw out the presence of the desired species, as discussed below. A machine incorporating the techniques of this application can operate through either controlled quantum or classical molecular manipulation of the agents. The techniques of this application can be adapted for discrimination and identification of a broad class of chemical and biological agents in laboratory, clinical, environmental, and field use. This application draws together desirable features of the emerging fields of quantum and classical molecular scale control and adapts them for performing chemical and bio-agent analysis under any operating conditions. The techniques of this application has a broad range of applications, including a variety of specific incarnations for chemical and biological agent discrimination and identification.

One or more computer programs may be included in the implementation of the apparatuses and methodologies of this application. The computer programs may be stored in a machine-readable program storage device or medium and/or transmitted via a computer network or other transmission medium.

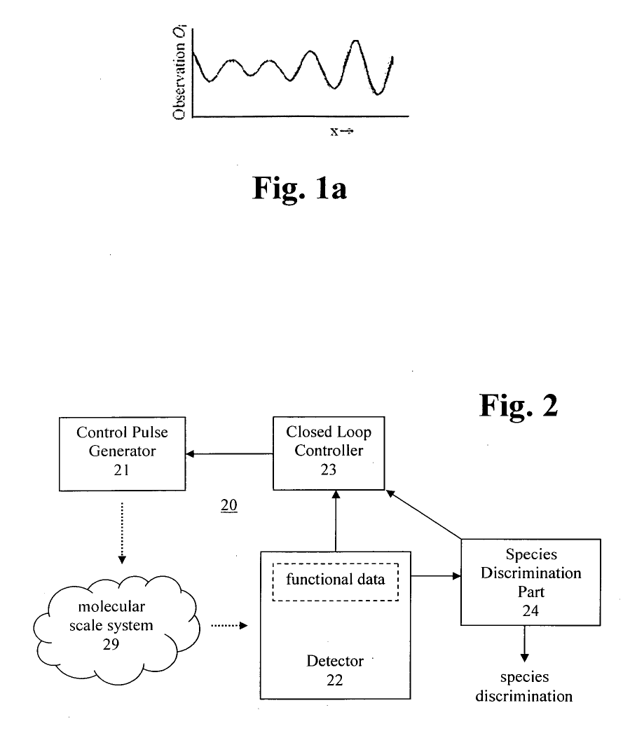

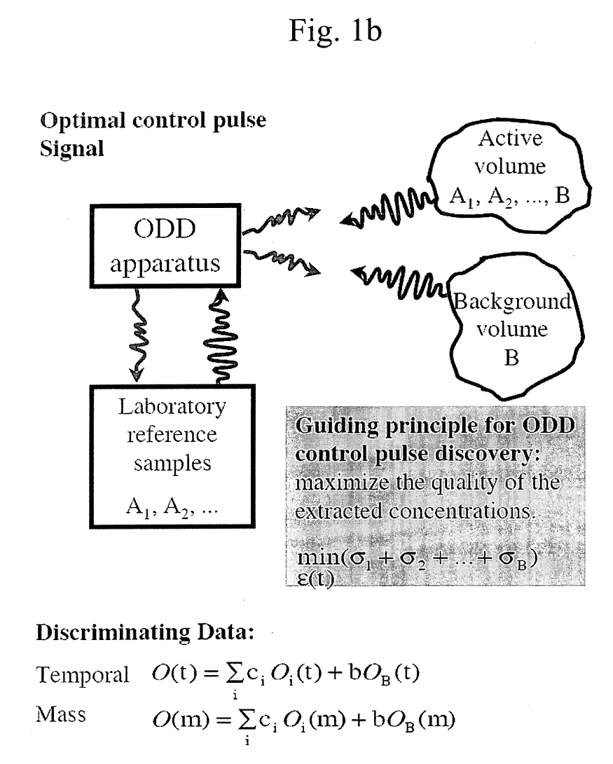

The techniques of the present disclosure can be use in a wide range of applications, and can be incorporated in, for example, quantum dynamic discriminator apparatuses for analyzing a composition, sample identification systems for determining characteristics of components in a composition, analytical spectrometers (such as mass spectrometers, nuclear magnetic resonance spectrometers, optical spectrometers, photoacoustic spectrometers, etc.), devices for determining the molecular structure of a quantum system, optimal identification devices for determining the quantum Hamiltonian of a quantum system, etc. Examples of such apparatuses are disclosed in commonly owned U.S. applications Ser. No. 10/322,693, filed Dec. 18, 2002, and Ser. No. 10/505,941, filed Aug. 25, 2004, the disclosures of which are incorporated herein in their entireties by reference. Additional examples are discussed in U.S. applications Ser. No. 10/265,211, filed Oct. 4, 2002, and Ser. No. 10/628,874, filed Jul. 28, 2003 (Dantus et al.). A dynamic discriminator 20 for a molecular scale system, according to an exemplary embodiment (FIG. 2) of this application, includes a control pulse generator 21, a detector 22, a closed loop controller 23 and a species discrimination part 24.

The control pulse generator 21 generates a control pulse. The control pulse can be applied to molecular scale system 29 to create tailored excitation in one of a plurality of molecular species in the molecular scale system. The control pulse can include one of an electromagnetic radiation pulse, an electrical pulse and a chemical pulse.

The detector 22 collects functional data for an observable variable from a molecular scale system after the control pulse generated by the control pulse generator is applied to the molecular scale system to excite one or more molecular species in the molecular scale system.

The closed loop controller 23 controls generation of the control pulse by the control pulse generator, for dynamically discriminating one of a plurality of molecular species in the molecular scale system from another molecular species in the molecular scale system. The closed loop controller can control the control pulse generator to shape the control pulse in at least one of time, frequency and space, in order to facilitate discrimination of the one of the plurality of molecular species in the molecular scale system from the other molecular species in the molecular scale system. For example, the control pulse generated by the control pulse generator can be an electromagnetic pulse, and the closed loop controller controls the control pulse generator to shape the electromagnetic control pulse in at least one of frequency, wavelength, amplitude, phase, timing and duration of the electromagnetic control pulse.

The species discrimination part 24 discriminates the one of the plurality of molecular species in the molecular scale system from the other molecular species in the molecular scale system, by using the collected functional data. The closed loop controller may adjust the control pulse, in order to allow the species discrimination part to discriminate the one of the plurality of molecular species in the molecular scale system from a background of the other molecular species in the molecular scale system. The closed loop controller may apply a cost function to guide a determination of an adjustment to be made to the control pulse. The species discrimination part may determine a concentration of the one of the plurality of molecular species in the molecular scale system, by using the collected functional data.

For example, the functional data can include time series data, and the species discrimination part 24 uses the time series functional data to discriminate the one of the plurality of molecular species in the molecular scale system from a background of the other molecular species in the molecular scale system.

As another example, the functional data includes mass spectra data, and the species discrimination part 24 uses the mass spectra data to discriminate the one of the plurality of molecular species in the molecular scale system from a background of the other molecular species in the molecular scale system. According to another exemplary embodiment, the functional data includes spectral frequency data, and the species discrimination part 24 uses the spectral frequency data to discriminate the one of the plurality of molecular species in the molecular scale system from a background of the other molecular species in the molecular scale system.

The dynamic discriminator may be incorporated in an analytical spectrometer (for example, a mass spectrometer, a nuclear magnetic resonance spectrometer, an optical spectrometer, a photoacoustic spectrometer, any combination thereof, etc.). For example, the analytical spectrometer may comprise a sample chamber and the dynamic discriminator, and the control pulse generated by the control pulse generator of the dynamic discriminator is applied to the molecular scale system when the molecular scale system is placed in the sample chamber. According to another exemplary embodiment, the observable variable is independent, the observable independent variable is mass, and the detector is included in a mass spectrometer.

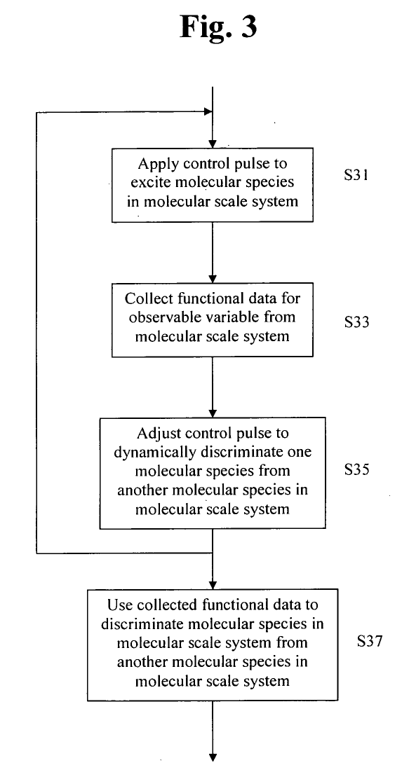

Exemplary embodiments of a method for molecular scale discrimination using functional data are discussed below with reference to FIGS. 2 and 3.

A method for molecular scale discrimination using functional data, according to one exemplary embodiment (FIG. 3), can comprising the steps of (a) applying a control pulse (from the control pulse generator 21) to excite one or more molecular species in the molecular scale system 29 (step S31), (b) collecting functional data for an observable variable from the molecular scale system (step S33) after the control pulse is applied in step S31, (c) adjusting the control pulse under the control of the closed loop controller 23, for dynamically discriminating one of a plurality of molecular species in the molecular scale system from another molecular species in the molecular scale system (step S35), and repeating steps S31 and S33 with the adjusted control pulse, and (d) discriminating the one of the plurality of molecular species in the molecular scale system from the other molecular species in the molecular scale system, by using the collected functional data (step S37). The method may further comprise one or more of the following steps: determining a concentration of the one of the plurality of molecular species in the molecular scale system, by using the collected functional data; and obtaining an analytical spectrum of the one of the plurality of molecular species in the molecular scale system.

The observable variable is preferably independent, and the observable independent variable includes at least one of time, frequency and mass. A dependent variable as a function of the observable independent variable can constitute the functional data.

The one of the plurality of molecular species in the molecular scale system can be similar in chemical properties, physical properties and/or spectral properties to at least one of the other molecular species in the molecular scale system. The plurality of molecular species are preferably non-interacting (but may be interacting). The plurality of molecular species may include a plurality of chemical agents and/or biological agents. An identity of at least one of the other molecular species in the molecular scale system may be unknown.

The one of the plurality of molecular species in the molecular scale system can be discriminated (by the species discrimination part 24) in a presence of an unknown background species in the molecular scale system 29, by using the collected functional data.

A cost function can be applied by the closed loop controller 23 to guide a determination of an adjustment to be made to the control pulse. The cost function can include a quality of the concentration, determined by using the collected functional data, of the one of the plurality of molecular species in the molecular scale system. The cost function can include one or more other constraints on the adjustment to the control pulse. In the preferred embodiment, the objective of optimal control is to maximize the quality of the extracted concentrations (FIG. 1b).

The functional data can include time series data, and the time series data is used to discriminate the one of the plurality of molecular species in the molecular scale system from a background of the other molecular species in the molecular scale system. According to another exemplary embodiment, the functional data includes intensity data associated with at least one of spectral absorption, light or particle scattering, and mass spectral data.

The control pulse can be shaped in at least one of time, frequency and space, in order to facilitate discrimination of the one of the plurality of molecular species in the molecular scale system from the other molecular species in the molecular scale system. According to one exemplary embodiment, the control pulse is an electromagnetic pulse, and the electromagnetic control pulse is shaped in at least one of frequency, wavelength, amplitude, phase, timing, duration of the electromagnetic pulse.

Non-limiting details of additional exemplary embodiments are described below, including discussions of theory and experimental simulations which are set forth to aid in an understanding of this disclosure but are not intended to, and should not be construed to, limit in any way the claims which follow thereafter.

Example Using Time Series Data

Optimal Dynamic Discrimination (ODD) techniques are discussed in Ser. No. 10/322,693, filed Dec. 18, 2002 and entitled “QUANTUM DYNAMIC DISCRIMINATOR FOR MOLECULAR AGENTS”, as a paradigm for discriminating non-interacting similar quantum systems in a mixture. Refinements of the ODD techniques to optimize a laser control pulse for guiding similar quantum systems such that each quantum system exhibits a distinct time series signal for maximum discrimination are discussed herein. The use of temporal data addresses various experimental difficulties, including noise in the laser pulse, signal detection errors, and finite time resolution in the signal. Simulations of ODD with time series data to explore these effects are discussed herein. As also discussed herein, the ODD techniques also can be adapted for the case where the sample contains unknown background species.

A fundamental principle underlying ODD is the controllability of the mixture of species, and a practical level of discriminating control is expected to exist in realistic circumstances. ODD techniques exploit the richness of quantum dynamics to amplify even the subtle differences between species through the use of optimized control laser pulses. Simulation of ODD techniques demonstrates that very similar systems can exhibit distinct signals at a prescribed moment in time, making discrimination possible. A quantum control mechanistic analysis of the ODD approach demonstrated that discrimination arises due to constructive and destructive interferences created in distinct ways in each species [Li et al. 2002; Mitra et al. 2004]. In a practical demonstration of the concept, quantum optimal control was employed in the laboratory to discriminate between one isotopic species of K₂ over another [Lindinger et al. 2004]. Learning control may be applied to attain the maximum degree of discrimination while working with all of the laboratory exigencies [Judson 1992].

Because of its flexibility, ODD can accommodate various experimental situations and demands. This application discusses an adaptation to ODD wherein time series data is collected instead of signals at a single time. The disparately driven similar quantum systems can be envisioned to exploit quantum interferences to produce discernible temporal signals, while in contrast, detection at a specific time is likely to be more sensitive to noise and limitations from finite time resolution. An additional benefit of working with time series data is the ready extraction of the concentrations of all of the similar species, assuming that the signal of each species is linearly proportional to its concentration, and the signal of the mixture is the sum of those from its component species.

The ability to quantitatively determine the species concentrations can be extended beyond the linear additive regime. Quantitative discrimination can be performed if the relationship between the signal of the mixture and the concentrations of the species, S(t,c¹,c², . . . , c^{N}), is a well-defined function of the concentrations c¹,c², . . . , c^{N} with a unique inverse.

Assessment of this capability (discussed below) accounts for the inherent presence of laboratory noise, including in the shaped laser control pulses, and the detection of the dynamic signals under finite time resolution. A number of theoretical and simulation studies, as well as the many successful quantum control experiments, suggest that optimal quantum control has a high degree of robustness to noise [Rabitz et al. 2004; Geremia 2000].

Implementation of ODD with time series data, under reasonable conditions of laser and observation noise as well as finite time resolution, is discussed below. Learning control simulations were performed on few-level systems for illustrative purposes, as also discussed below.

Consider a mixture composed of M non-interacting species with similar Hamiltonians, with each member labeled by an identifying index v=1,2, . . . , M. The analysis can be just as well carried out for the M components also interacting together. In this case two or more interacting species just act as a single species where the target for discrimination is between the two or more interacting parts as arises in conventional quantum control experiments.

A decoherence-free wavefunction formulation was developed to examine the basic concepts, but a more comprehensive density matrix treatment may be considered. The dynamics of each system is characterized by a wavepacket |ψ^{v}(t)>. Initially at time −T, each species is in its respective ground state,
|ψ^{v}(−T)>=|ψ₀^{v}> (1)

Over the interval −T≧t≧T, a common control laser pulse, ε_{c}(t), interacts with all of the species simultaneously, and guides the states to |ψ^{v}(T)>, v=1,2, . . . , M. Each species follows the dynamics prescribed by its Schrödinger's equation during the control process,

$$i ℏ \frac{\partial }{\partial t} \vert {ψ}^{v} ( t ) \text{〉} = [ {H}_{0}^{v} - {μ}^{v} {∈}_{c} ( t ) ] \vert {ψ}^{v} ( t ) \text{〉} \\ - T \leq t \leq T \qquad ( 2 )$$

The state |ψ^{v}(t)>, is assumed to be expressed in terms of a finite number of eigenstates, |φₒ^{v>,|φ}₁^{v}>, . . . , |φ_{N-1}^{v}> with,
H₀^{v}|ψᵢ^{v}>=Eᵢ^{v}|ψᵢ^{v}> <φᵢ^{v}|μ|φⱼ^{v}>=μᵢⱼ^{v} i,j=0,1, . . . , N-1 (3)

H₀^{v} is the internal control-free Hamiltonian, Eᵢ^{v} are its energy levels, and μᵢⱼ^{v} are the dipole moment matrix elements. Each species propagates freely after the control is off,

$$i ℏ \frac{\partial }{\partial t} \vert {ψ}^{v} ( t ) \text{〉} = {H}_{0}^{v} \vert {ψ}^{v} ( t ) \text{〉} \\ t \geq T \qquad ( 4 )$$

with the evolution described by the following:

$$\vert {ψ}^{v} ( t ) \text{〉} = {\sum }_{i = 0}^{N - 1} {α}_{i}^{v} ( T ) exp [ - \frac{{iE}_{i}^{v} ( t - T )}{ℏ} ] \vert {ϕ}_{i}^{v} \\ t \geq T \qquad ( 5 )$$

Detection can occur during the internal −T≧t≧T, but a more likely circumstance is the performance of observations for t≦T. In this case the discriminating role of the control is encoded in the constant coefficients αᵢ^{v}(T). During free propagation after the control pulse is off, a short detection laser pulse ε_{d} excites one or all of the wavepackets, described by the evolution U_{d}^{v} for ultimate projection onto the detection state, |Γ^{v}>,

$$\begin{matrix}{O}^{v} ( t ) = {\vert 〈 {Γ}^{v} \vert {U}_{d}^{v} \vert {ψ}^{v} ( t ) 〉 \vert}^{2} \\ = {\vert {\sum }_{i = 0}^{N - 1} {a}_{i}^{v} ( t ) \cdot 〈 {Γ}^{v} \vert {U}_{d}^{v} {ϕ}_{i}^{v} \vert 〉 \vert}^{2} \\ = {\vert {\sum }_{i = 0}^{N - 1} {a}_{i}^{v} ( T ) exp [ - \frac{{iE}_{i}^{v} ( t - T )}{ℏ} ] {D}_{i}^{v} \vert}^{2}\end{matrix} \\ t \geq T \qquad ( 6 )$$

where Dᵢ^{v}=<Γ^{v}|U_{d}^{v}|φᵢ^{v}>. The specific nature of the detection pulse ε_{d}, its propagator U_{d}^{v} and the detection state |Γ^{v}> can be put aside here and is simply encapsulated into the coefficients Dᵢ^{v}. In practice, a sequence of experiments are performed with pulses eˆ{t) shifted further along in time relative to T to generate a temporal data track. Assuming that the signal from each species is linearly proportional to its concentration c^{v}, the signal from the mixture is the sum of the signals from all of the species, which can be represented as follows:

$$O ( t ) = {\sum }_{v = 1}^{M} {c}^{v} {O}^{v} ( t ) \qquad ( 7 )$$

The signals O¹(t),O²(t), . . . , O^{M}(t) may be separately recorded from standard pure samples of all of the individual species 1,2, . . . , M under the same conditions as generating O(t). In practice the data O(tᵢ) is recorded at a number of distinct times t₁,t₂, . . . , tₚ,

$${O}_{i} = O ( {t}_{i} ) = {\sum }_{v = 1}^{M} {c}^{v} {O}^{v} ( {t}_{i} ) \\ i = 1 , 2 , … , P \qquad ( 8 )$$

The concentrations of each species can be extracted by solving the above set of linear equations. Ideally, P the number (P) of signals is equal to the number (M) of species in the mixture. However, there is inevitable laboratory noise from various sources and finite temporal resolution that can blur the signals O(t) and O^{v}(t), causing errors in determining the concentrations from the data. Therefore, more signals are recorded (P>M), and the concentrations can be determined using the least-square method with the physical inequality constraints (c^{v}≦0, v=1,2, . . . , M). Quantum optimal control experiments commonly employ signal averaging, performed with multiple runs using nominally the same control. The outcome of each experiment can also be recorded on a shot-to-shot basis to reveal the statistical nature of the signals. The simulations described below follow this practice and determine the mean concentrations of all of the species and their standard deviations after each experiment from temporal data using the shot-to-shot statistics arising in signal averaging. The cost function guiding the ODD experiments is based on the goal of enhancing the quality of the experiments by reducing the standard deviation of the extracted concentration distributions. Although the actual concentrations may not normally be distributed, their standard deviations generally suffice as species quality metrics to guide a sequence of experiments towards an optimal one that best determines the species concentrations.

In practice, the actual data collected is a convolution of O(t) with a window function p(t) representing the temporal resolution in the experiment. The process may be expressed as follows:

$${O}^{v} ( t ) = {\int }_{- ∞}^{+ ∞} {O}^{v} ( τ ) p ( τ - t ) ⅆ τ \qquad ( 9 )$$

where p(t) has as a specified temporal width δt reflecting the observation resolution. An increasing loss of resolution (i.e., corresponding to a larger value of δt) tends to wash out the detailed oscillatory structure expected in O^{v}(t), making the individual signals from each species less distinct, and thus more difficult to discriminate.

The goal of the simulations is to illustrate the basic principles of ODD with temporal data including the effects of noise and finite time resolution. For this purpose, a simple mixture of three similar quantum systems was studied. Each species has ten levels with energies Eᵢ^{v}, dipole moment matrix elements μᵢⱼ^{v} and projection parameters Dᵢ^{v}, each of which is chosen randomly yet similarly, along the same lines of the ten-level simulation case discussed previously [Li et al. 2002] (i.e., the various physical constants differ on the scale of ˜1%). The simulation results are expressed in dimensionless units for all of the physical quantities.

The control fields in the simulations are constrained to the following form:

$${∈}_{c} ( t ) = {ⅇ}^{- ( t / κ ) 2} {\sum }_{l = 1}^{L} {a}_{l} cos ( {ω}_{l} t + {θ}_{l} ) \\ - T \leq t \leq T \qquad ( 10 )$$

in which κ=20 and T=50. The frequencies ω₁ include all of the 45 possible transitions between the 10 energy levels of each of the three species (L=45×3=135), with the goal that the learning algorithm properly optimize the control variable amplitudes α₁ and phases θ₁ over the intervals [0,1] and [0, 2π], respectively. When noise is present in the phases they may go beyond the interval [0, 2Tπ], but the periodicity of the cosine function in equation (10) wraps them around to be in the same interval. The Schrödinger equation, equation (2), is solved with the propagation toolkit method [Yip et al. 2003].

As discussed above, in view of the presence of noise the control experiments are performed under the algorithmic guidance of deducing an optimal field ε_{c}(t) that best reduces the standard deviation of one or more of the extracted concentrations for all of the species. As the target concentrations are not known beforehand, the experiments are strictly guided by the quality of the data reflected in the concentration standard deviations. When no particular species in the mixture is afforded preferential consideration, the functional J for the learning algorithm is defined as the average of the standard deviations (σ^{v}) of the concentrations of all three species:

$$\begin{matrix}\begin{matrix}J [ ∈ c ( t ) ] \frac{1}{3} {\sum }_{v = 1}^{3} {σ}^{v} & {σ}^{v} = \sqrt{\frac{{\sum }_{j = 1}^{{j}^{*}} {( {c}_{j}^{v} - {c}_{j}^{v} )}^{2}}{{j}^{*} - 1}}\end{matrix} & \overline{{c}^{v}} = \frac{1}{{j}^{*}} {\sum }_{j = 1}^{{j}^{*}} {c}_{j}^{v}\end{matrix} \qquad ( 11 )$$

\overline{c}^{v} is the average concentration from j* runs of the experiment with nominally the same laser pulse (i.e., a signal averaged result). In all of the simulations, j*=100 proved to be statistically sufficient. A steady-state genetic algorithm (GA) is implemented to minimize J by modifying a GA software package, GALib [available at http://lancet.mit.edu/ga/]. Real-valued genomes, instead of binary genomes, are used to represent the control variables (α₁ and θ₁); each genome corresponds to a laser pulse. In the simulations each laser pulse amplitude α₁ and phase θ₁ is assumed to have Gaussian distributed relative noise of width ±e_{θ}and absolute noise of width ±e_{θ}, respectively. The accounting for the noise does not imply that the pulse shaper has such errors, but this procedure is a convenient way to model the laser pulse shot-to-shot variations. The time resolution function in equation (9) is chosen as follows:

$$p ( τ - t ) = \frac{exp [ - {( \frac{τ - t}{δ t} )}^{2} ]}{δ t \sqrt{π}} \qquad ( 12 )$$

The convolution in equation (9), due to finite time resolution δt, affects the structure of the signals, and thus the determination of the optimal control pulse. There is also noise (eₒ) in the detected signal, which is assumed to be Gaussian distributed and relative at each sampled time point.

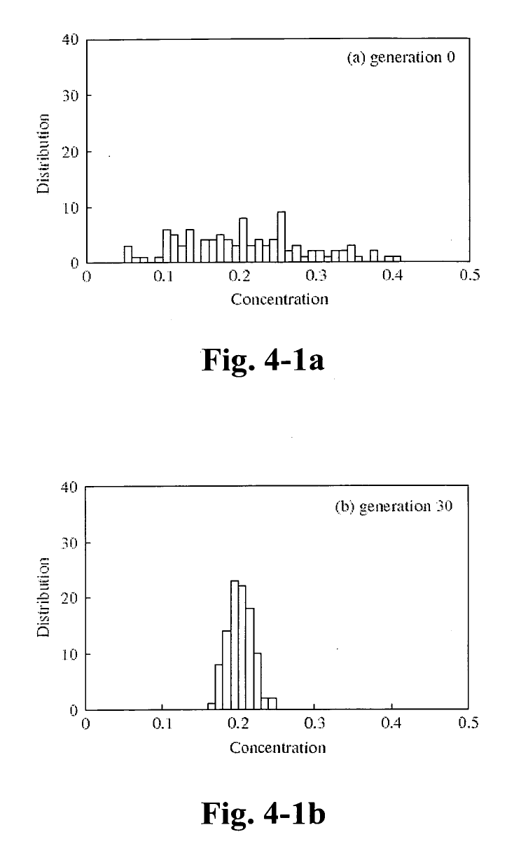

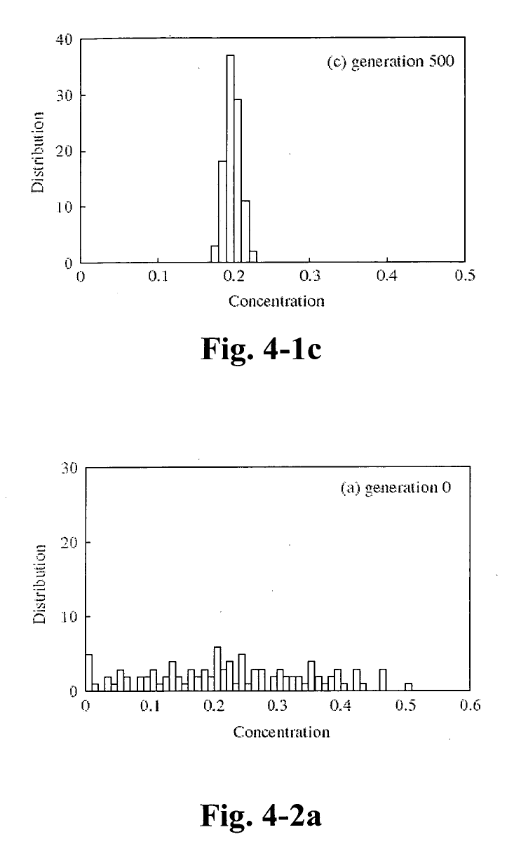

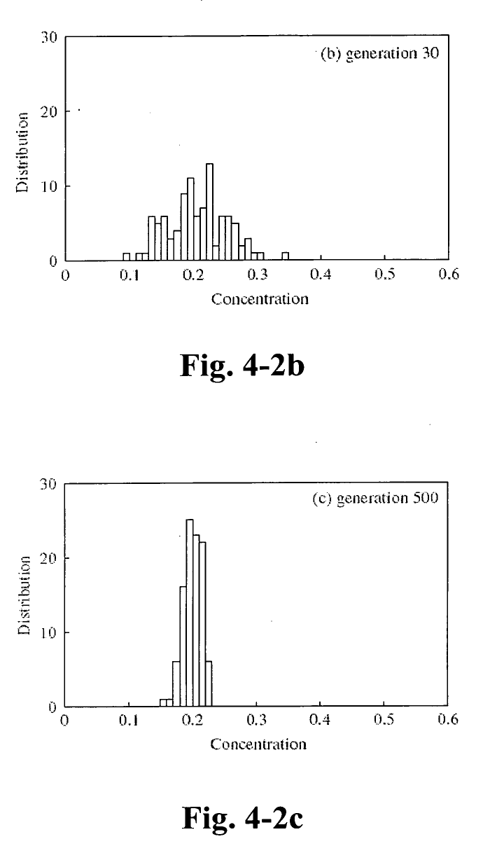

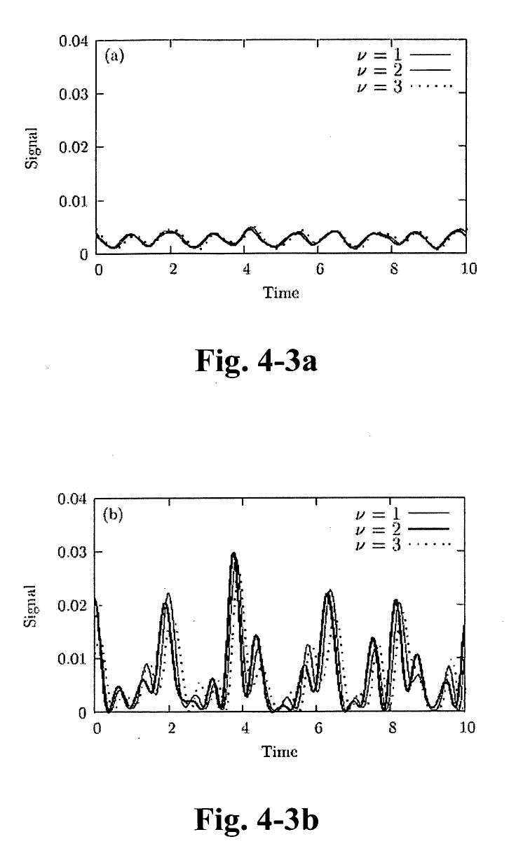

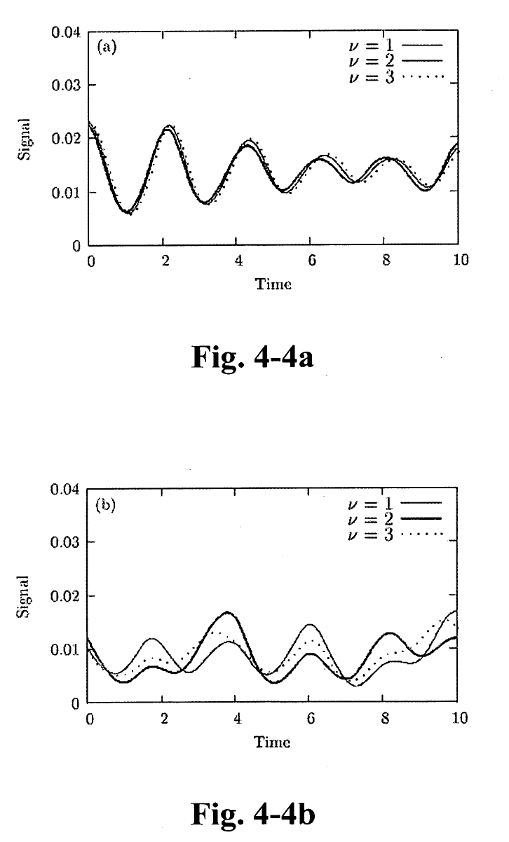

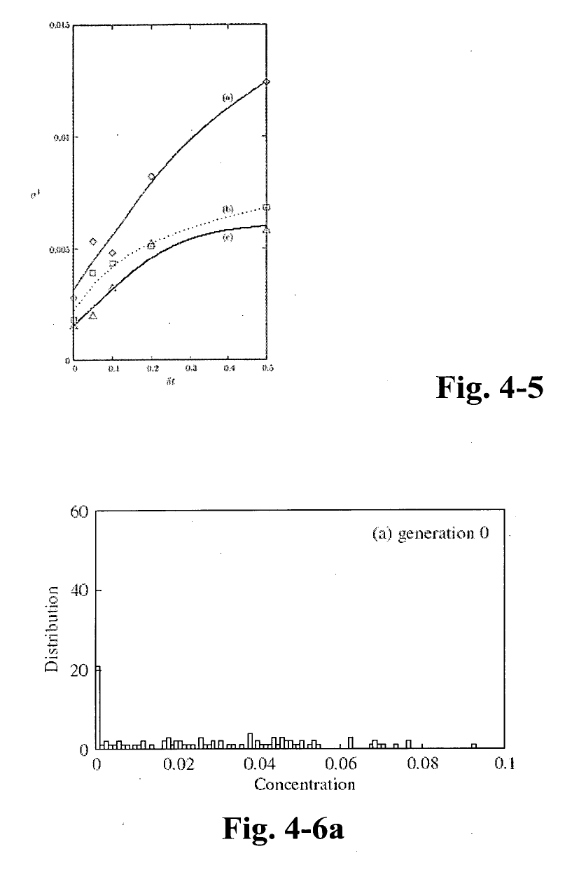

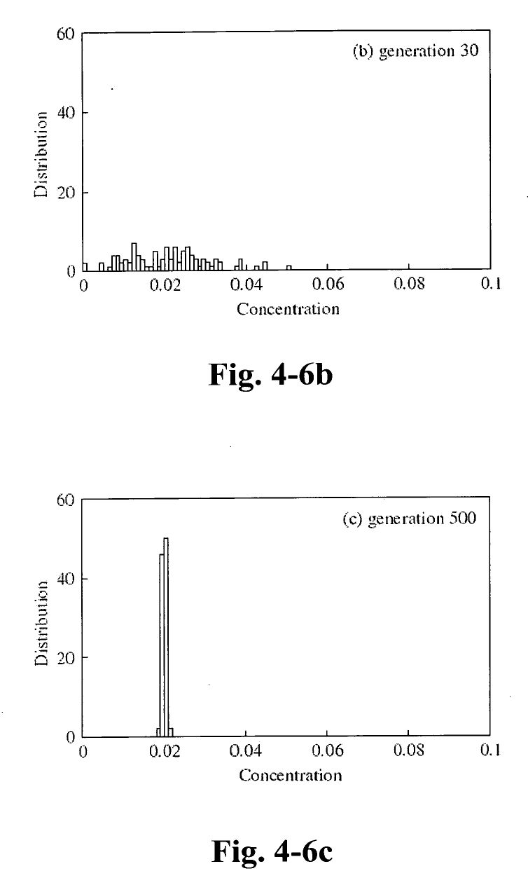

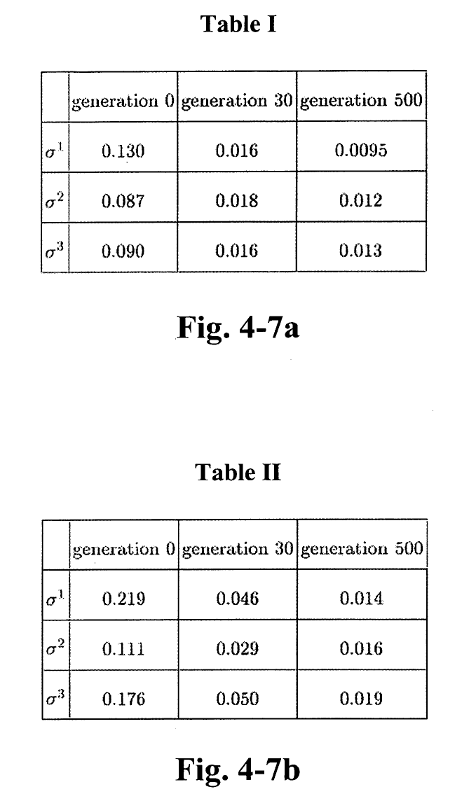

In the simulation results shown in FIG. 4-1, the actual concentrations are c¹=0.2, c²=0.5, and C³=0.9, and the noise is eₐ=2%, eₑ_{θ}=0.02. rad, and eₒ=2%. The goal is to minimize the average standard deviation in equation (11) under the influence of noise and in the presence of finite signal time resolution. Since species 1 has the smallest concentration, its detection is more sensitive to noise and finite temporal resolution. Thus, the results primarily focus on species 1. As a reference case, FIGS. 4-1a through 4-1c shows the concentration distribution for c¹ due to noise at perfect temporal resolution, δt=0; in practice, this limit is approached for δt<h-(E₉^{v}−ED₀^{v})⁻¹, where all of the possible temporal signal O(t) features in equations (6) and (7) are fully resolved. The distribution, shown at each of the three generations (0, 30, and 500), is from the best control field of that generation (i.e., the field that yields the smallest standard deviation). In just 500 generations (and 18 genomes per generation), the GA is able to find an optimal laser pulse that can produce very narrow distributions for the three concentrations, as shown in Table I (FIG. 4-7a) for all three species. This convergence is evident in going from FIG. 4-1a to FIG. 4-1c for species 1. The average concentrations \overline{c}^{v} are found to be close to the true values, despite the noise, except at the initial generations. This behavior arises due to the rather symmetric distributions. Although the control and observation noise is modest at ˜2%, a randomly chosen control leads to a significant amplification of the noise in c¹ (i.e., see FIG. 4-7a and FIG. 4-1a), approximately being 65%. However, the optimal field reduces this error to just 4.8%. The optimal field similarly reduces the error in the species 2 and 3 of higher concentrations. Table II (FIG. 4-7b) and FIGS. 4-2a through 4-2c show the same general trends at a finite temporal resolution of δt=0.5, but the influence of introducing an optimal field is even more dramatic in this case. In general, the use of an optimal control field significantly enhances the quality (i.e., diminishes the statistical error), as evident in FIGS. 4-1c and 4-2c at the 500th generation. In the final generation 500 with the optimal control field the effect of finite time resolution at δt=0.5 is overcome, which is apparent upon comparing Tables I and II, as well as FIGS. 4-1 and 4-2, where only a modest increase in concentration uncertainty arises. This stable behavior is a result of the optimal control field drawing out the rich physical content in the temporal data, even at diminished resolution.

The influence of the optimal control field can be demonstrated by first considering the data generated with a randomly selected field acting on the three similar species. This circumstance is shown in FIG. 4-3a at full data resolution of δt=0. The time profiles nearly overlap each other, making it very difficult to achieve discrimination in the presence of noise, as reflected in the wide concentration distribution in FIG. 4-1a. FIG. 4-3b shows the analogous temporal data for the best field at generation 500. The time series profiles are clearly more distinct and easier to discriminate, which is evident in the average statistical errors being \overline{σ}=0.012 for the optimal pulse, but \overline{σ}=0.102 for a random pulse. The same general trend shows up at reduced temporal resolution, as shown in FIGS. 4-4a and 4-4b for δt=0.5. Here the mean variance with the optimal field is \overline{σ}=0.016, while for the random field it is \overline{σ}=0.169. A comparison of FIGS. 4-3b and 4-4b shows that the poorer temporal resolution in FIG. 4-4b led to an optimal field that further enhanced the distinction between the three species signals to attain the best quality for the extracted concentrations. In the case of perfect time resolution in FIG. 4-3b the optimal field was able to produce a highly complex set of discriminating waveforms, especially over that of a random pulse in FIG. 4-3a. In contrast, the loss of time resolution in FIGS. 4-4a and 4-4b forced the optimal field to exploit fewer temporal signal features, and achieve almost the same level of discrimination by more effectively working with the signal intensities. Upon inspection of the pair of pulses that yield optimal discrimination in FIGS. 4-3b and 4-4b, there is no apparent relationship between the phase or amplitude variables (i.e., α₁, and θ₁ in equation (10) in these cases. In general, the amplitude and phase variables affect the quality of the extracted concentrations in each case studied in this work.

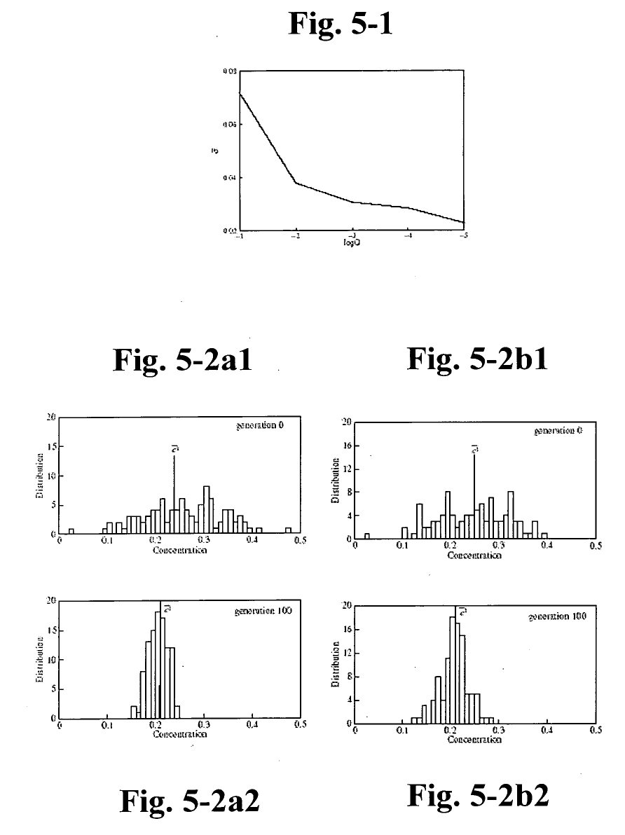

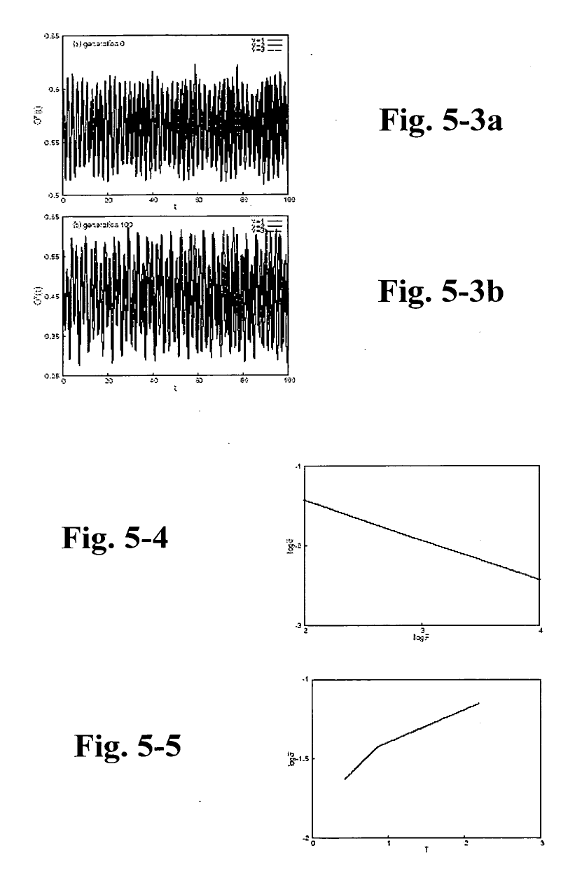

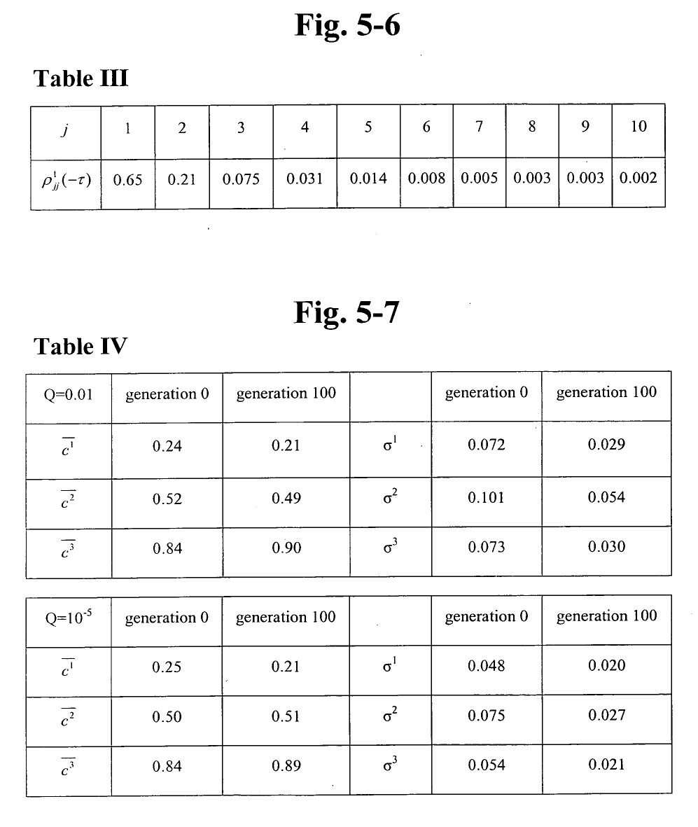

As a final example, consider the case where one concentration is significantly smaller than the others. This circumstance is expected to cause considerable difficulty for extracting the small concentration species. Another simulation was run on a mixture of the same three species with concentrations c¹=0.02, c²=0.2, and c³=0.5, with the same level and type of noise as in the earlier illustration. In this case, if a random control pulse is applied to the mixture, the concentration of species 1 is so small that its contribution to the overall signal is the same magnitude as that of the noise, making its concentration very difficult to extract. Nevertheless, by collecting optimal time series signals, the concentration of species 1 can be measured with some degree of confidence. For this purpose the GA optimization was carried out using the same cost functional shown in equation (11). Plot (a) in FIG. 4-5 shows the concentration standard deviation for species 1 versus the signal time resolution. Since the optimization goal is the average of the concentration standard deviations for all three species, the optimal control pulse typically does not guarantee the best standard deviation for species 1 alone. By searching over all of the 9,000 control pulses (500 generation×18 control pulses/generation) evaluated throughout the entire GA optimization process, the best control pulse for species 1 alone is identified in plot (b) in FIG. 4-5. In another round of simulations, the cost functional was modified to only include the concentration standard deviation for species 1, i.e., J=σ¹. The optimization results are shown in plot (c) in FIG. 4-5. A comparison of FIGS. 4-5a through 4-5c shows steady improvement in the quality of the extracted concentration for species 1 by focusing the experiments on this specific goal. The general tendency of the concentration standard deviation to inflate with δt points out the significance of reducing the signal time resolution δt as much as possible in the laboratory. The trends observed in going through the sequence of plots (a) through (c) in FIG. 4-5 are logical, but special cases were also found that yielded especially good ODD behavior. For example, the cost function choice J=(σ¹/\overline{c}¹+σ²+σ³)/3 produced the outcome shown in FIGS. 4-6a through 4-6c for full time resolution (δt=0) where a very narrow concentration distribution for species 1 is obtained (σ¹=0.00049). This value of σ¹ is a factor of three better than the result found in plot (c) in FIG. 4-5.

This cost function has a bias toward species 1 through the ratio σ¹/\overline{c}¹, while still providing some consideration to species 2 and 3. As a result, all three species are determined to an excellent degree with good-quality statistics also found for \overline{c}² and \overline{c}³, similar to that of the first illustration in Table I.

All of the collective behavior of ODD in the FIGS. and Tables discussed above clearly show the advantage of operating optimally, but they also point out that the search for an optimal control ε_{c}(t) for discrimination is a highly nonlinear process starting with the control appearing deeply buried in the quantum dynamics of equation (2) and further being affected by a number of factors including the detailed composition of the mixture, the type and level of noise, when the signals are collected, the nature of the search algorithm and how concentrations are extracted from the data. Simulations have found fiducial pulses that yield excellent standard deviations for the concentrations of different mixtures composed of the same components. This result demonstrates the possibility of building a library of pulses for the quantitative analysis of the same type of mixture with a range of concentrations for each component. Yet, to optimally obtain the concentrations for each specific mixture, the pulse can be optimized and applied in situ under each set of laboratory conditions.

A number of other simulations show that when additional data are taken [i.e., using a larger value of P in equation (8)], the resultant concentration standard deviations are generally smaller, and fewer trial control fields can be applied to reach convergence. With higher levels of noise, generally the concentration standard deviations rise and more experiments can be performed to reach the best possible results. In situations where a particular species is of special interest in the mixture, then the guiding standard deviation cost focusing on that species more heavily or even exclusively is most effective. These trends are rational.

Unknown Background Substance

A common circumstance is the desire to determine the concentrations c¹,c², . . . of similar species A₁,A₂, . . . in the presence of a concentration b of an unknown background substance B. The ODD technique may be readily adapted to this situation, provided that a reference signal O_{ref}^{B}(t) may be measured without the species A₁,A₂, . . . being present. Under this condition it is also assumed that the signal O_{ref}^{B}(t) may be recorded as the result of applying any of the trial controls ε_{c}(t) during the learning process to find an optimal field that best determines c¹,c², . . . This situation can often be realized where two distinct physical sample domains exist, with one sample domain being the active volume containing A₁,A₂, . . . and B, while the second sample domain is a background volume just containing B. This breakdown into active and background volumes naturally arises in many circumstances, including in the environment where the background volume corresponds to ambient conditions. In fact, the background volume can also contain the species A₁,A₂, . . . , as well as B, when the goal is to find the enhanced relative values of A₁,A₂, . . . in the active volume over that found in the background volume.

With the model above in mind equation (8) may be written as follows:

$$O ( t ) = {\sum }_{v = 1}^{M} {c}^{v} {O}^{v} ( t ) + {bO}_{ref}^{B} ( t ) \qquad ( 13 )$$

The ODD techniques can be implemented as formulated above to determine the concentrations c^{v} and b from an optimal control ε_{c}(t). Although b is treated as an unknown here, typically it has unit value as the ambient concentration of B is likely the same in the active and background volumes (i.e., the signal O_{ref}^{B}(t) already has factored in the ambient concentration from the background volume). In practice, each trial control ε_{c}(t) is applied to (i) a pure sample of species A₁,A₂, . . . , (ii) the background volume and (iii) the active volume with a record kept of all of the associated shot-to-shot statistics for use in the cost function. This overall operation is exactly the same as the original case discussed above, with the unknown B treated as an additional substance to be discriminated.

The procedure for discriminating A₁,A₂, . . . in the presence of an unknown B does not require a physical/chemical identification of the nature of B. The “species” B can itself be a mixture of several unknown components. The additional task of identifying the physical/chemical nature of B in a distinct objective is beyond what is presented here. However, the data O_{ref}^{B}(t) including its Fourier transform for spectral analysis, under the various trial control fields, is likely rich in additional information from which one can infer the makeup of B. The general tools of optimal control for signal enhancement can be applied to this task, possibly including mass and other spectroscopies, to determine the components in B if this is desired.

The proposed ODD techniques adapted to use time series data are a more robust way to detect similar species than recording a signal at a single time. The simulations show that an optimal control field can significantly reduce the effects of laboratory noise and finite time resolution on the extracted species concentrations. The quality of the extracted information is addressed directly, as it drives the cost function of the learning algorithm.

Although, in general, noise reduces the coherence of quantum dynamics, previous studies have shown that optimal pulses can be found through learning control that can either fight against or cooperate with noise to best attain the control objectives [Shuang et al. 2004]. The simulation results presented herein indicate that the optimal control pulse can fight against the noise to reduce the standard deviation of the concentration distribution. Experiments and simulations similarly show that the signal-to-noise ratio can be enhanced in other quantum control contexts [Geremia et al. 2000]. Finite time resolution in signal detection can cause significant loss of dynamical features, as shown upon comparing FIGS. 4-3 and 4-4, and thus increase the demands on the optimal control to assure the quality of the discrimination. This loss of time resolution affects use of ODD with a signal at a single time. However, ODD employed with time series data can still retain high discrimination sensitivity despite the blurring of the signals. In this case the learning algorithm seeks an optimal pulse to maximally draw out the differences among the signals for the similar species, as shown in FIG. 4-4b.

The simulations presented herein address two of the practical problems, noise and finite time resolution, for carrying out ODD in the laboratory. Another factor is the decoherence caused by the coupling between the system and the environment. The mechanism by which ODD achieves its discrimination can be a subtle process relying on manipulating quantum mechanical constructive and destructive interferences. A mechanism analysis of ODD performed at a single observation time revealed how these interferences work together in the different species [Mitra et al. 2004].

Presence of Decoherence

Optimal Dynamic Discrimination (ODD) of a mixture of similar quantum systems with time series signals enables the extraction of the associated concentrations with reasonable levels of laser pulse noise, signal detection errors, and imperfect signal detector resolution. The ODD paradigm can be re-expressed in a density matrix formulation (discussed below) to allow for the consideration of environmental decoherence on the quality of the extracted concentrations, along with the above listed factors. Simulations show that although starting in a thermally mixed state along with decoherence can be detrimental to discrimination, these effects can be counteracted by seeking a suitable optimal control pulse. Additional sampling of the temporal data also aids in extracting more information to better implement ODD.

Similar molecules, due to their comparable composition and structure, are difficult to discriminate because of their closely related chemical and physical properties. Optimal Dynamic Discrimination (ODD) with static or temporal signals aims to maximally draw out the differences among similar molecules by manipulating their quantum dynamics with optimized laser or other control pulses. Recent experiments have demonstrated the feasibility of ODD and the fundamental controllability of multiple quantum systems also has been examined. Simulations have demonstrated the capabilities of optimal discrimination in the presence of control pulse noise, signal detection errors, and imperfect signal detection resolution. However, the examined multi-level quantum systems were all treated as being pure states, isolated from the surrounding environment. Their quantum evolution was correspondingly described by wave functions satisfying the Schrödinger equation during the entire control and signal collection process. Starting in a mixed state along with the presence of decoherence causes a loss of phase information and is generally detrimental to achieving high quality optimal quantum control. However, optimal control simulations have demonstrated the capability to overcome decoherence effects. The discussion below explores ODD in the presence of decoherence and initially mixed states as well as various possible disturbances, the dynamical equation governing the open quantum systems, and the ODD principles for extracting the concentrations from time series data.

Consider a mixture of M species having similar Hamiltonians, with each member labeled by an identifying index v=1,2. . . , M and having N levels φ₁^{v},φ₂^{v}, . . . , φ_{N}^{v} in its active dynamic control space. The interactions between the species are assumed to be negligible, and each species interacts with the same surrounding environment. The analysis can be just as well carried out for the M components also interacting together. In this case two or more interacting species just act as a single species where the target for discrimination is between the two or more interacting parts as arises in conventional quantum control experiments.

In any event, the dynamics of each species and the environment together follows the Liouville equation, as follows:

$$\begin{matrix}i \frac{\partial }{\partial t} {ρ}^{v} ( t ) = [ {H}^{v} , {ρ}^{v} ( t ) ] & [ {H}^{v} , {ρ}^{v} ( t ) ] =\end{matrix} {H}^{v} , {ρ}^{v} ( t ) - {ρ}^{v} ( t ) {H}^{v} \qquad ( 5 \text{-} 1 )$$

The total Hamiltonian H^{v} includes contributions from the species H_{S}^{v}, the environment H_{E}, and their interaction H₁^{v}, as follows:
H^{v}=H_{S}^{v}+H_{E}=H₁^{v} (5-2)

In most cases, only the dynamics of the species, not the environment, is of interest, and it is described by tracing out the environment to produce the reduced density matrix, as follows:
ρ_{S}^{v}(t)=Tr_{E}ρ^{v}(t) (5-3)
The corresponding Liouville equation for the reduced density matrix is, as follows:

$$\begin{matrix}i \frac{\partial }{\partial t} {ρ}_{S}^{v} ( t ) = {Tr}_{E} [ {H}^{v} , {ρ}^{v} ( t ) ] \\ = [ {H}_{S}^{v} , {ρ}_{S}^{v} ( t ) ] + {Tr}_{E} [ {H}_{l}^{v} , ρ v ( t ) ]\end{matrix} \qquad ( 5 \text{-} 4 )$$

In deriving Eq. (5-4), the relation Tr_{E}[H_{E}^{v},ρ^{v}(t)]=0 was used. By formally representing the interaction between the species and the environment as the general functional F^{v}, Eq. (5-4) can be written as follows:

$$i \frac{\partial }{\partial t} {ρ}_{S}^{v} ( t ) = [ {H}_{S}^{v} , {ρ}_{S}^{v} ( t ) ] + {F}^{v} \{ {ρ}_{S}^{v} ( t ) \} \qquad ( 5 \text{-} 5 )$$

Barring very special cases, the interaction between the species and the environment, Hᵢ^{v}, is generally very complicated and not yet clearly understood, making it impossible to write the explicit form of the interaction functional F^{v}. But, under the assumption of the Markov approximation (i.e., no memory effects) and the constraints of conserving the normality and positivity of the reduced density matrix ρ_{S}^{v}, Eq. (5-5) takes the form of the Lindblad equation, as follows:

$$\begin{matrix}i \frac{\partial }{\partial t} {ρ}^{v} ( t ) = [ {H}^{v} , {ρ}^{v} ( t ) ] + i {\sum }_{j , k = 1}^{N} \\ [ {L}_{jk}^{v} {ρ}^{v} ( t ) {L}_{jk}^{v +} - \frac{1}{2} {ρ}^{v} ( t ) {L}_{jk}^{v +} {ρ}^{v} ( t ) ]\end{matrix} \qquad ( 5 \text{-} 6 )$$

For simplicity, the subscript S representing the species has been dropped in the above equation, and is also left out in the discussion below. The Lindblad operators, Lⱼₖ^{v}, cause kinetic-type transitions between the states of each species, and can be expressed phenomenologically as follows:
Lⱼₖ^{v}=\sqrt{λⱼₖ^{v}|j><k|}j,k,=1,2, . . . , N (5-7)
where λₖ^{v} is the transition rate from state k to state j. Assuming that states j and k are non-degenerate, and Eⱼ^{v}<Eₖ^{v}, the transition rates λⱼₖ^{v} and λₖⱼ^{v} are expressed in the following form:

$${γ}_{jk}^{v} = \frac{Q {\vert {μ}_{jk}^{v} \vert}^{2}}{1 - exp \text{[} ( {E}_{j}^{v} - {E}_{k}^{v} ) / ( {k}_{B} T )} \\ {γ}_{kj}^{v} = \frac{Q {\vert {μ}_{kj}^{v} \vert}^{2}}{exp [ ( {E}_{k}^{v} - {E}_{j}^{v} ) / ( {k}_{B} T ) ] - 1} \qquad ( 5 \text{-} 8 )$$

where k_{B} is the Boltzmann constant and T is the absolute temperature. These rates serve as a simplified model which builds in reasonable physical properties. Choosing other appropriate functional forms does not affect the operating principles of ODD. In Eq. (5-8), |μⱼₖ^{v}|² makes the transition rates proportional to the related absolute square of the transition dipole moment matrix element. The denominator ensures detailed balance between states j and k, and the Boltzmann distribution of the state populations (i.e., the diagonal elements of the density matrix) at field-free equilibrium satisfies the following:

$$\begin{matrix}{ρ}_{kk}^{v} {γ}_{jk}^{v} - {ρ}_{jj}^{v} {γ}_{kj}^{v} = 0 & \frac{{ρ}_{jj}^{v}}{{ρ}_{kk}^{v}} = \frac{{γ}_{jk}^{v}}{{γ}_{kj}^{v}} = exp [ - ( {E}_{j}^{v} - {E}_{k}^{v} ) / {k}_{B} T ]\end{matrix} \qquad ( 5 \text{-} 9 )$$

The factor Q in Eq. (5-8) is introduced for convenience to adjust the overall strength of the decoherence in the simulations. λⱼⱼ^{v} are zero because there is no self-coupling.

The Lindblad equation for the density matrix, Eq. (5-6), can now be written in the following computationally convenient form:

$$\begin{matrix}i \frac{\partial }{\partial t} {ρ}^{v} ( t ) = [ {H}_{0}^{v} - {μ}^{v} {∈}_{c} ( t ) , {ρ}^{v} ( t ) ] + i {\sum }_{j , k = 1}^{N} {γ}_{jk}^{v} \\ [ \vert j 〉 〈 k \vert {ρ}^{v} ( t ) \vert k 〉 〈 j \vert - \frac{1}{2} {ρ}^{v} ( t ) \vert k 〉 〈 k \vert - \frac{1}{2} \vert k 〉 〈 k \vert {ρ}^{v} ( t ) ]\end{matrix} \qquad ( 5 \text{-} 10 )$$

By expressing the elements of the density matrix as ρⱼₖ(t)=>j|ρ(t)|k, the above equation can be written as a set of coupled differential equations, as follows:

$$i \frac{\partial }{\partial t} {ρ}_{jk}^{v} ( t ) = ( {E}_{j}^{v} - {E}_{k}^{v} ) {ρ}_{jk}^{v} ( t ) - {∈}_{c} ( t ) {\sum }_{n = 1}^{N} [ {μ}_{jn}^{v} {ρ}_{nk}^{v} ( t ) - {ρ}_{jn}^{v} {μ}_{nk}^{v} ( t ) ] + i {δ}_{jk} {\sum }_{n = 1}^{N} {γ}_{jn}^{v} {ρ}_{nn}^{v} ( t ) - \frac{i}{2} {ρ}_{jk}^{v} ( t ) {\sum }_{n = 1}^{N} ( {γ}_{nj}^{v} + {γ}_{nk}^{v} ) \qquad ( 5 \text{-} 11 )$$

Initially at time −T, the density matrices of all the species are assumed to be Boltzmann distributed at temperature T, as follows:

$${P}^{v} = {\sum }_{j = 1}^{N} exp [ - {E}_{j}^{v} / {k}_{B} T ] {ρ}_{jj} ( - τ ) = \frac{exp [ - {E}_{j}^{v} / {k}_{B} T}{{P}^{v}} \qquad ( 5 \text{-} 12 )$$

which is also the field-free equilibrium state of the following Master equation:

$$\frac{\partial }{\partial t} {ρ}_{jj}^{v} = {\sum }_{k \neq j} [ {ρ}_{kk}^{v} {γ}_{jk}^{v} - {ρ}_{jj}^{v} {γ}_{kj}^{v} ] j = 1 , 2 , ⋯ , N \qquad ( 5 \text{-} 13 )$$

when the transition rates are defined in Eq. (5-8). P^{v} is the partition function. Thus, at the initial time −τ the systems are in thermal equilibrium with the surroundings. The temperature affects both the initial coherence of the density matrix (reflected in Tr[(ρ^{v}(τ))²]) and the rate of decoherence (through the transition rates λⱼₖ). All the molecules are manipulated by the same control pulse ε_{c}(t) over the interval −τ≧t≧τ. During the field-free propagation after the control pulse is turned off at time τ, decoherence effects continue and a detection laser pulse ed projects the molecules to a detection state |Γ^{v}> to produce a signal. Expressing the propagator associated with ε_{d} as U_{d}^{v} (i.e., the detection operation itself is assumed to be fast compared to the decoherence time), the projection of the density matrix is then represented by the operator U_{d}^{v1}|Γ^{v}><Γ^{v}|U_{d}^{v} and the signal for t≧τ is as follows:

$$\begin{matrix}{O}^{v} ( t ) = Tr [ {U}_{d}^{vt} \vert {Γ}^{v} 〉 〈 {Γ}^{v} {U}_{d}^{v} \vert {ρ}^{v} ( t ) ] \\ = {\sum }_{j = 1}^{N} 〈 {ϕ}_{j}^{v} \vert {U}_{d}^{vt} \vert {Γ}^{v} 〉 〈 {Γ}^{v} \vert {U}_{d}^{v} {ρ}^{v} ( t ) \vert {ϕ}_{j}^{v} 〉 \\ = {\sum }_{j , k = 1}^{N} 〈 {ϕ}_{j}^{v} \vert {U}_{d}^{vt} \vert {Γ}^{v} 〉 〈 {Γ}^{v} \vert {U}_{d}^{c} \vert {ϕ}_{k}^{v} \vert 〉 〈 {ϕ}_{k}^{v} \vert {ρ}^{v} ( t ) \vert {ϕ}_{j}^{v} 〉 \\ = {\sum }_{j , k = 1}^{N} {\hat{D}}_{kj}^{v} {ρ}_{jk}^{v} ( t ) = Tr [ {\hat{D}}^{v} {ρ}^{v} ( t ) ]\end{matrix} \\ {\hat{D}}_{kj}^{v} = {{D}_{k}^{v} ( {D}_{j}^{v} )}^{*} {D}_{j}^{v} = 〈 {Γ}^{v} \vert {U}_{d}^{v} \vert {ϕ}_{j}^{v} \qquad ( 5 \text{-} 14 )$$

D^{v} are the same projection parameter vectors used in previous wave function formulations [Li et al. 2002], and D^{v} is a Hermitian matrix. The nature of the detection process, including the pulse ε_{d}, its propagator U_{d}^{v}, and the detection state |Γ^{v} > are not specified here and can simply be subsumed in the matrix D^{v}. Assuming that the signal from the mixture is the sum of the signals from all the species, and that signal from each species is linearly proportional to its concentration c^{v}, then the signal from the mixture is,

$$O ( t ) = {\sum }_{v = 1}^{M} {c}^{v} {O}^{v} ( t ) t \geq τ \qquad ( 5 \text{-} 15 )$$

The signals O¹(t), O²(t), . . . , O^{M}(t) are separately recorded from standard pure samples of the individual species 1,2, . . . , M, under the same conditions as O(t) is recorded. In the laboratory, a sequence of experiments may be performed with the detection pulse ε_{d} moved along in time relative to r to generate a temporal data series at a number of distinct times t₁,t₂, . . . , tₚ, as follows:

$${O}_{i} = O ( {t}_{i} ) = {\sum }_{v = 1}^{M} {c}^{v} {O}^{v} ( {t}_{i} ) i = 1 , 2 , ⋯ , P \qquad ( 5 \text{-} 16 )$$

This set of linear equations is solved for the concentrations of each species. Ideally, if there is no error in the recorded signals, then the number of signals, P, only needs to be the same as M, the number of species in the mixture. Inevitable laboratory noise from various sources can cause errors in the extracted concentrations. Thus, more signals can be recorded (P>M), and the concentrations determined using the least-squares method with the physical inequality constraints c^{v}>0, v=1,2, . . . , M. For similar molecules without an optimal control, the temporal signal profiles O^{v}(t) tend to look alike due to the similar quantum dynamic behavior of the species. The goal of ODD is to force distinguishing signals to be present despite the similarity of the molecules and the presence of various disturbances and imperfections.

In practice, the actual collected data are a convolution of O(t) with a window function p(t) representing the temporal resolution δt in the signal detection process of the experiment, as follows:

$${O}^{v} ( t ) = {\int }_{- ∞}^{+ ∞} {O}^{v} ( {t}^{′} ) p ( {t}^{′} - t ) ⅆ {t}^{′} \qquad ( 5 \text{-} 17 )$$

The loss of resolution tends to diminish the detailed oscillatory structure in the signal O^{v}(t), making the individual signals from each species less distinct for discrimination. In addition, environmental decoherence tends to decrease the amplitude of the off-diagonal elements of the density matrix, which is again reflected in the oscillations of the signals. A higher temperature also spreads out the population in the initial diagonal density matrix. All of these effects result in a reduction of the signal amplitude, making the signal profiles more similar and the discrimination of the similar species more difficult.

Optimally selected control pulses can fight against limited detector resolution, laser noise and the signal detection errors, to ultimately reduce to uncertainties of the extracted concentrations as much as possible (the concentration uncertainties define the quality measure for optimization). The presence of decoherence is expected to increase the demands on selecting the proper optimal pulse, in the same spirit shown previously for achieving other optimal control objectives.

The purpose of the simulations is to illustrate the basic principles of ODD with temporal data under the influence of environmental decoherence. As the roles of laser noise, detection error, and signal resolution were explored earlier, these processes are set at reasonable levels with the focus on the influence of decoherence. The multi-level systems are similar to those in previous simulations [Li et al. 2002] with H_{S}^{v}=H₀^{v}−με_{c}(t), with H₀^{v} being the diagonal field-free Hamiltonian. A simple mixture of three similar quantum systems is studied here. Each species has ten levels with energies Eⱼ^{v}, dipole moment matrix elements μⱼₖ^{v}, and projection parameters \hat{D}ⱼₖ all chosen randomly yet similarly (i.e., the various physical constants randomly differ on the scale of ˜1% across the species). The simulation results are expressed in dimensionless units for all physical quantities.

The control field ε_{c}(t) in the simulations is constrained to have a Gaussian envelope modulated by a collection of cosine waveforms, as follows:

$${∈}_{c} ( t ) = {ⅇ}^{- ( t / η ) 2} {\sum }_{l = 1}^{L} {a}_{l} cos ( {ω}_{l} t + {θ}_{l} ) - τ \leq t \leq τ \qquad ( 5 \text{-} 18 )$$

in which η=20 and τ=50. The frequencies ωᵢ include all 45 possible transitions between the ten energy levels of each of the three species (L=45 ×=135), with the goal that the learning algorithm properly optimize the control variable amplitudes α₁ and phases θ₁ over the intervals [0,1] and [0,2π], respectively. When noise is present in the phases they may go beyond the interval [0,2π], but the periodicity of the cosine function in Eq. (5-18) wraps them around to be effectively in the same interval. In the simulations reported below, the explicit control fields or their transforms are not shown as they generally do not exhibit any easily discernible features; the discussions below focus on the effectiveness of ODD.

The concentrations are not extracted from the averaged signals from multiple runs of the experiment with the same nominal control pulse ε_{c}. Instead, the concentrations are calculated on a shot-to-shot basis, with the mean and standard deviation of the concentrations determined from the collection of experiments, as similarly performed in other optimal control laboratory scenarios. Since the actual concentrations are not known beforehand, the standard deviations of the extracted concentration distributions are used as the measure of their quality. Therefore, the cost function for guiding the ODD experiments is based on the goal of enhancing the quality of the experiments by reducing the standard deviation of the extracted concentration distributions. Although the actual concentrations may not be normally distributed, their standard deviations suffice as quality metrics to guide a sequence of experiments toward an optimal one that best determines the species concentrations. When no particular species in the mixture is given preferential consideration, the functional J for the learning algorithm is defined as the average of the standard deviations (σ^{v}) of the concentrations of all three species, as follows:

$$J [ {∈}_{c} ( t ) ] = \overline{σ} = \frac{1}{3} {\sum }_{v = 1}^{3} {σ}^{v} \\ {σ}^{ v} = \sqrt{ \frac{ {\sum }_{j = 1}^{ {j}^{*}} {( {c}_{ j}^{ v} - { {c}_{ j}^{ v}}^{ \_} )}^{2}}{ {j}^{*} - 1}} \\ \overline{{c}^{v}} = \frac{1}{{j}^{*}} {\sum }_{j = 1}^{{j}^{*}} {c}_{j}^{v} \qquad ( 5 \text{-} 19 )$$

Here \overline{c}^{v} is the average concentration from j* runs of the experiment with nominally the same laser pulse (i.e., a signal averaged result). In all the simulations, j*=100 proved to be statistically sufficient. A steady-state genetic algorithm is implemented to minimize J by modifying the GA software package, GAlib. Real-valued genomes, instead of binary genomes, are used to represent the control variables α₁ and θ₁, each genome corresponds to a laser pulse. In the simulations each laser pulse amplitude α₁ and phase θ₁ is assumed to, respectively, have Gaussian distributed relative noise of width ±e_{α} and absolute noise of width ±e_{θ}. In addition, there is also noise eₒ in the detected signal, which is assumed to be Gaussian distributed and relative at each sampled time point. The noise levels in the following simulations are e_{α}=2%, e_{θ}=0.02 rad, and eₒ=2%. The noises e_{α} and e_{θ} are not meant to imply that the pulse shaper has such errors, but this procedure is a convenient way to model the laser pulse shot-to-shot variations. The time resolution function in Eq. (5-17) is chosen as follows:

$$p ( {t}^{′} - t ) = \frac{exp [ - {( \frac{{t}^{′} - t}{δ} )}^{2} ]}{δ t \sqrt{π}} \qquad ( 5 \text{-} 20 )$$

The convolution in Eq. (5-17), due to finite time resolution δt, affects the structure of the signals, and thus the determination of the optimal control pulse. All the test cases in this discussion have a finite resolution in the signal detection of δt=0.5. The goal is to minimize the average standard deviation in Eq. (5-19) under the influence of noise in both the laser pulse and the signal detection process, the presence of finite signal time resolution and the influence of decoherence. The Lindblad equation, Eq. (5-11), is solved numerically with the fourth-order Runge-Kutta method.

The simulations are first carried out on a mixture of three similar species using P=100 signals uniformly placed to extract the concentrations (the actual values are c¹=0.2, c²=0.5, and c³=0.9). The choice of P=100 over the temporal data window is a very coarse sampling and thus represents a rather minimal amount of information as an initial reference case. The role of P is addressed below. The temperature T in this discussion is expressed in units of E₁¹/k_{B}. The nominal simulations are carried out with T=0.88, and the diagonal elements of the initial density matrix for species 1 shown in Table III (FIG. 5-6) are calculated as follows:

$${ρ}_{jj}^{1} = \frac{exp [ - {E}_{j}^{1} / ( {k}_{B} T ) ]}{{\sum }_{j = 1}^{N} exp [ - {E}_{j}^{1} / ( {k}_{B} T ) ]} \qquad ( 5 \text{-} 21 )$$

The initial coherence in species 1 is Tr[(p¹(−τ))²]=0.476, corresponding to a rather mixed state as demonstrated in FIG. 5-6. The initial density matrix and coherence at time −τ of species 2 and 3 are slightly different due to the small differences in their energy levels. The effect of decoherence on the quality of the discrimination is explored by varying the factor Q in Eq. (5-8) over the range of 10⁻¹ to 10⁻⁵, and the average standard deviations a from the optimal pulse of each GA run are shown in FIG. 5-1. The standard deviations σv for each species drawn from both the random pulse (generation 0) and the optimal pulse (generation 100) for both Q 32 0.01 and Q=10⁻⁵ are shown in Table IV (FIG. 5-7), and the corresponding concentration distributions for species 1 are given in FIGS. 5-2a1 through 5-2b2 (those of species 2 and 3 show similar improvements upon moving from the random pulse to the optimal pulse). FIGS. 5-2a1 through 5-2b2 show that when the decoherence is small (Q=10⁻⁵) the application of the optimal pulse significantly enhances the quality of the extracted concentration distributions. When the decoherence increases (Q=0.01) the quality of the optimally extracted concentrations decreases with a fixed amount of data, set at P=100 in this example. For the cases in FIG. 5-7 and FIGS. 5-2a1 through 5-2b2 a random pulse gives skewed distributions with mean concentrations \overline{c}¹ which are too large. However, the optimal pulse removes this artifact as well as improves the quality of the extracted concentrations. When the decoherence is too strong (Q=0.1), it becomes very difficult to find an effective optimal pulse with only P=100 data samples. Calculations also show that the coherence in the density matrix reflected in Tr[ρ²] after the propagation by either the random pulse or the optimal pulse is not very different from its initial value, probably because fighting decoherence is not directly the goal in the GA optimization functional.

The working principles for the optimal pulse can be analyzed from the signal curves for both a random pulse and the optimal pulse with no laser or detection noise, as presented in FIGS. 5-3a and 5-3b for the Q=10⁻⁵ case. Although there is highly oscillatory structures in the signals generated by the random pulse (generation 0), their amplitudes are small over a dynamic range of ˜0.1 permitting the laser and detection noise to hide the subtle differences, therefore leading to poor concentration results. In contrast, the signals generated by the optimal pulse (generation 100) have notably increased oscillation amplitudes over a dynamic range of ˜0.36, thereby permitting the extracted concentrations to be of high quality and much less affected by the laser pulse and detection noise even with the limited amount of data at P=100. Additional structure is also evident in the signals of FIG. 5-3b over that of FIG. 5-3a reflecting the more complex dynamics generated by the optimal pulse to better discriminate the three similar species. The same trend appears in the signal curves for other Q values up to 0.01 for P=100. At Q=0.1, the strong effects of the environment are evident (not shown here) with the signals significantly decaying on the same time interval in FIGS. 5-3a and 5-3b.

The ability to discriminate can be enhanced by increasing the number of samples P. For the case of Q=0.01, and T=0.88, FIG. 5-4 shows that the average standard deviations of the extracted concentrations can be dramatically improved by increasing the number of signal samples P with the approximate scaling \overline{σ}˜P^{-1/2} consistent to the same rule governing random sampling. The significant impact of increasing P can be seen from FIGS. 5-3a and 5-3b where the nominal case of P=100 used above is very coarse given the rich nature of the signals. The same trend is evident at all values of Q, including Q=0.1, which did not yield to ODD at P 100. In the latter case the optimal pulse for P=100 produces an average standard deviation of 0.069, while increasing P to 10,000 with the same optimal control pulse deduced at P=100 significantly improved the average standard deviation to 0.013. However, GA optimization with P=10,000 yields an even better average standard deviation of 0.0078.

With Q=0.01, FIG. 5-5 shows that when the temperature T increases, the quality of the extracted concentrations decreases. This is mainly due to the increased decoherence rate with increasing temperature, as shown in Eq. (5-8), and the decreased initial coherence in the density matrix (for example, if T=2.16, then Tr[(ρ¹(−τ))²]=0.017). The influence of increased temperature on the discrimination quality can be similarly counteracted by increasing the number of sampled signals P.

Decoherence is detrimental in many controlled quantum dynamics applications, including with ODD of similar molecules. Its full impact for ODD depends on many factors including the temperature, the nature of the environment, the level of control and observation noise, the temporal signal resolution and the amount of available data. Some of these factors can be managed while others overcome with an optimal control. In any event, closed-loop learning control seeks the best possible performance. The example discussed above focused on temporal signals, but other types of sequence data can be used as well. Another example is mass spectral data where O^{v}(tᵢ) in Eq. (5-16) can be replaced by the mass spectral intensity O^{v}(mᵢ) at mass mᵢ. Again, the control is sought to best enhance the quality of the species discrimination. For mass spectral data, the initial state is likely mixed, but environmental decoherence is not generally an issue. Each laboratory or field scenario has its own features to deal with, and seeking ODD is always the best procedure to maximally draw out all of the detection capabilities.

The specific embodiments described herein are illustrative, and many variations can be introduced on these embodiments without departing from the spirit of the disclosure or from the scope of the appended claims. Features of different illustrative embodiments (such as from the examples) may be combined with each other and/or substituted for each other within the scope of this disclosure and appended claims.

### REFERENCES

1. L. Accardi, Y. G. Lu, and I. Volovich, Quantum theory and its stochastic limit (Springer-Verlag, Berlin, 2001).
2. Assion, A.; Baumert, T.; Bergt, M.; Brixner, T.; Kiefer, B.; Seyfried, V.; Strehle, M.; Gerber, G. Science 1998, 282, 919.
3. Bardeen, C. J.; Yakovlev, V. V.; Wilson, K. R.; Carpenter, S. D.; Weber, P. M.; Warren, W. S. Chem. Phys. Lett. 1997, 280, 151.
4. H. A. Barnett and A. Bartoli, Anal. Chem. 32, 1153 (1960).
5. Bartels, R.; Backus, S.; Zeek, E.; Misoguti, L.; Vdovin, G.; Christov, I. P.; Murnane, M. M.; Kapteyn, H. C. Nature 2000, 406, 164.
6. K. Blum, Density Matrix Theory and Applications, 2nd Ed. (Plenum Press, New York, N.Y., 1996).
7. Brixner, T.; Damrauer, N. H.; Niklaus, P.; Gerber, G. Nature 2001, 414, 57.
8. Dantzig, G. B.; Thapa, M. N. Linear Programming New York: Springer, N.Y. 1997.
9. Geremia, J. M.; Zhu, W.; Rabitz, H. J. Chem. Phys. 2000, 113, 3960.
10. Gross, P.; Neuhauser, D.; Rabitz, H. J. Chem. Phys. 1991, 94, 1158.
11. Hornung, T.; Meier, R.; Zeidler, D.; Kompa, K. L.; Proch, D.; Motzkus, M. Appl. Phys. B2000, 71, 277.
12. Judson, R. S.; Rabitz, H. Phys. Rev. Lett. 1992, 68, 1500.
13. Levis, R. J.; Menkir, G.; Rabitz, H. Science 2001, 292, 709.
14. Li, B.; Turinici, G.; Ramakrishna, V.; Rabitz, H. J. Phys. Chem. B 2002, 106, 8125.
15. G. Lindblad, Commum. Math. Phys. 119, 48 (1976).
16. Lindinger, A.; Lupulescu, C.; Plewicki, M.;

Vetter, F.; Merli, A.; Weber, S. M.; Woste, L. Phys. Rev. Lett. 2004, 93, 033001.
17. Mitra, A.; Rabitz, H. J. Phys. Chem. 2004, 108, 4778.
18. Ohtsuki, Y.; Zhu, W.; Rabitz, H. J. Chem. Phys. 1999, 110, 9825.
19. Y. Ohtsuki, K. Nakagami, Y. Fujimura, W. Zhu, and H. Rabitz, J. Chem. Phys. 114, 8867 (2001).
20. Ohtsuki, Y.; Nakagami, K.; Zhu, W.; Rabitz, H. Chem. Phys. 2003, 287, 197.
21. Ohtsuki, Y. J. Chem. Phys. 2003, 119, 661.
22. W. H. Press, S. A. Teukolsky, W. T. Vetterling, and B. P. Flannery, Numerical Recipes in C: the Art of Scientific Computing Second Edition (Cambridge University Press, New York, N.Y., 1992).
23. Rabitz, H.; Hsieh, M.; Rosenthal, C. Science 2004, 303, 998.
24. M. Shapiro and P. Brumer, Principles of the Quantum Control of Molecular Processes (Wiley-Interscience, Hoboken, N.J., 2003).
25. Shuang, F.; Rabitz, H. J. Chem. Phys. 2004, 121, 9270.
26. J. C. Sternberg, H. S. Stillo, and R. H.

Schwendeman, Anal. Chem. 32, 84 (1960).
27. Turinici G.; Ramakrishna, V.; Li, B.; Rabitz, H. J. Phys. A 2004, 37, 273.
28. Vajda, S.; Bartelt, A.; Kapostaa, E. C; Leisnerb, T.; Lupulescua, C; Minemotoc, S.; Rosendo-Franciscoa, P.; Woste, L. Chem. Phys. 2001, 267, 231.
29. Xu, R.; Yan, Y. J.; Ohtsuki, Y.; Fujimura, Y.; Rabitz, H. J. Chem. Phys. 2004, 120, 6600.
30. Yip, F.; Mazziotti, D.; Rabitz, H. J. Chem. Phys. 2003, 118, 8168.
31. Zhu, W.; Rabitz, H. J. Chem. Phys. 2003, 118, 6751.

What is claimed is:

1. A method for molecular scale discrimination using functional data, said method comprising the steps of:
(a) applying a control pulse to excite one or more molecular species in a molecular scale system;
(b) collecting functional data for an observable variable from the molecular scale system after the control pulse is applied in step (a);
(c) adjusting the control pulse under the control of a closed loop controller, for dynamically discriminating one of a plurality of molecular species in the molecular scale system from another molecular species in the molecular scale system, and repeating steps (a) and (b) with the adjusted control pulse; and
(d) discriminating the one of the plurality of molecular species in the molecular scale system from the other molecular species in the molecular scale system, by using the collected functional data.

2. The method of claim 1, wherein the one of the plurality of molecular species in the molecular scale system is discriminated in a presence of an unknown background species in the molecular scale system, by using the collected functional data.

3. The method of claim 1, wherein the one of the plurality of molecular species in the molecular scale system is similar in chemical properties to at least one of the other molecular species in the molecular scale system.

4. The method of claim 1, wherein the one of the plurality of molecular species in the molecular scale system is similar in physical properties to at least one of the other molecular species in the molecular scale system.

5. The method of claim 1, wherein the one of the plurality of molecular species in the molecular scale system is similar in spectral properties to at least one of the other molecular species in the molecular scale system.

6. The method of claim 1, further comprising determining a concentration of the one of the plurality of molecular species in the molecular scale system, by using the collected functional data.

7. The method of claim 6, wherein a cost function is applied by said closed loop controller to guide a determination of an adjustment to be made to the control pulse.

8. The method of claim 7, wherein the cost function includes a quality of the concentration, determined by using the collected functional data, of the one of the plurality of molecular species in the molecular scale system.

9. The method of claim 7, wherein the cost function includes one or more other constraints on the adjustment to the control pulse.

10. The method of claim 1, wherein the functional data includes time series data, and the time series data is used to discriminate the one of the plurality of molecular species in the molecular scale system from a background of the other molecular species in the molecular scale system.

11. The method of claim 1, wherein said observable variable is independent, and said observable independent variable includes at least one of time, frequency and mass.

12. The method of claim 1, wherein said observable variable is independent, and a dependent variable as a function of said observable independent variable constitutes the functional data.

13. The method of claim 1, wherein said functional data includes intensity data associated with at least one of spectral absorption, light or particle scattering, and mass spectral data.

14. The method of claim 1, wherein said control pulse includes one of an electromagnetic radiation pulse, an electrical pulse and a chemical pulse.

15. The method of claim 1, wherein said control pulse is shaped in at least one of time, frequency and space, in order to facilitate discrimination of the one of the plurality of molecular species in the molecular scale system from the other molecular species in the molecular scale system.

16. The method of claim 1, wherein said control pulse is an electromagnetic pulse, and the electromagnetic control pulse is shaped in at least one of frequency, wavelength, amplitude, phase, timing, duration of the electromagnetic pulse.

17. The method of claim 1, wherein an identity of at least one of the other molecular species in the molecular scale system is unknown.

18. The method of claim 1, wherein a cost function is applied by said closed loop controller to guide a determination of an adjustment to be made to the control pulse.

19. The method of claim 1, wherein said plurality of molecular species includes a plurality of chemical agents and/or biological agents.

20. The method of claim 1, further comprising obtaining an analytical spectrum of the one of the plurality of molecular species in the molecular scale system.

21. The method of claim 1, wherein said plurality of molecular species are non-interacting or interacting.

22. A dynamic discriminator for a molecular scale system, said dynamic discriminator comprising:
a control pulse generator configured to generate a control pulse;
a detector configured to collect functional data for an observable variable from a molecular scale system after the control pulse generated by the control pulse generator is applied to the molecular scale system to excite one or more molecular species in the molecular scale system;
a closed loop controller configured to use a close loop technique to control generation of the control pulse by the control pulse generator, for dynamically discriminating one of a plurality of molecular species in the molecular scale system from another molecular species in the molecular scale system; and
a species discrimination part configured to discriminate the one of the plurality of molecular species in the molecular scale system from said another of the plurality of molecular species in the molecular scale system, by using the collected functional data.

23. The dynamic discriminator of claim 22, wherein the functional data includes time series data, and said species discrimination part uses the time series functional data to discriminate the one of the plurality of molecular species in the molecular scale system from a background of the other molecular species in the molecular scale system.

24. The dynamic discriminator of claim 22, wherein the functional data includes mass spectra data, and said species discrimination part uses the mass spectra data to discriminate the one of the plurality of molecular species in the molecular scale system from a background of the other molecular species in the molecular scale system.

25. The dynamic discriminator of claim 22, wherein the functional data includes spectral frequency data, and said species discrimination part uses the spectral frequency data to discriminate the one of the plurality of molecular species in the molecular scale system from a background of the other molecular species in the molecular scale system.

26. The dynamic discriminator of claim 22, wherein said species discrimination part determines a concentration of the one of the plurality of molecular species in the molecular scale system, by using the collected functional data.

27. The dynamic discriminator of claim 22, wherein said control pulse is applied to the molecular scale system to create tailored excitation in the one of the plurality of molecular species in the molecular scale system.

28. The dynamic discriminator of claim 22, wherein said closed loop controller controls said control pulse generator to shape the control pulse in at least one of time, frequency and space, in order to facilitate discrimination of the one of the plurality of molecular species in the molecular scale system from the other molecular species in the molecular scale system.

29. The dynamic discriminator of claim 22, wherein said control pulse generated by said control pulse generator is an electromagnetic pulse, and said closed loop controller controls said control pulse generator to shape the electromagnetic control pulse in at least one of frequency, wavelength, amplitude, phase, timing and duration of the electromagnetic control pulse.

30. The dynamic discriminator of claim 22, wherein said observable variable is independent, said observable independent variable is mass, and said detector is included in a mass spectrometer.

31. The dynamic discriminator of claim 22, wherein said closed loop controller adjusts the control pulse, in order to allow said species discrimination part to discriminate the one of the plurality of molecular species in the molecular scale system from a background of the other molecular species in the molecular scale system.

32. The dynamic discriminator of claim 22, wherein said closed loop controller applies a cost function to guide a determination of an adjustment to be made to the control pulse.

33. An analytical spectrometer comprising:
a sample chamber; and
the dynamic discriminator of claim 22,
wherein the control pulse generated by the control pulse generator of the dynamic discriminator is applied to the molecular scale system when the molecular scale system is placed in the sample chamber.

34. The analytical spectrometer of claim 23, wherein the analytical spectrometer comprises a mass spectrometer, a nuclear magnetic resonance spectrometer, an optical spectrometer, a photoacoustic spectrometer, or any combination thereof.

35. The method of claim 1, wherein said closed loop controller uses a cost function to deduce an optimal control for enhancing a quality of discrimination.
